(19) United States
(12) Patent Application Publication
(10) Pub. No.: US 2002/0188528 A1
(43) Pub. Date: Dec. 12, 2002

(54) Part mapping system and method

(75) Inventors: Todd Adelman, Rollinsford, NH (US); Patrick El-Azem, Tyngsboro, MA (US)

Correspondence Address: NIXON PEABODY, LLP, 8180 GREENSBORO DRIVE, SUITE 800, MCLEAN, VA, 22102, US

(73) Assignee: Trade Wings, Inc., Portsmouth, NH

(21) Appl. No.: 10/108,998

(22) Filed: Mar. 29, 2002

Related U.S. Application Data
(60) Provisional application No. 60/279,421, filed on Mar. 29, 2001.

(51) Int. Cl. G06F 17/60

(52) U.S. Cl. 705/28; 707/3

(57) ABSTRACT

A parts mapping system, a data storage media with computer executable instructions, and a method for mapping internal part numbers to manufacturer part numbers. In one embodiment, the parts mapping system includes an input device to allow input of an internal part number, a database of internal part numbers and manufacturer part numbers correlated to one another, and a processor. The processor is preferably adapted to determine whether the inputted manufacturer part number is stored in the database and generates a data set having at least one manufacturer part number stored in the database which is correlated to the inputted internal part number. The data set preferably includes plurality of manufacturer part numbers stored in the database which are correlated to a plurality of internal part numbers stored in the database, the plurality of internal part numbers being correlated to at least one manufacturer part number.

This application claims priority to U.S. Provisional Application No. 60/279,421 filed Mar. 29, 2001, the contents of which are incorporated herein by reference.

### BACKGROUND OF THE INVENTION

1. Field of the Invention

The present invention is directed to a system and method for mapping parts to facilitate transactions associated to the mapped parts.

2. Description of Related Art

Electronic products are manufactured using various electronic parts such as inductors, capacitors, resistors, transistors, integrated circuits, and other parts. These parts are generally considered inseparable units of manufacture for such electronic products. Thus, as used herein, the terms “part” and “product” are distinguished in that a part is considered to be a unit of manufacture such as a resistor, while a product is considered to be a manufactured good made from assembly of such parts and materials, such as a semiconductor component, for example.

Manufactured products that use electronic parts are typically subject to a pre-manufacturing process including design of the end product, and sourcing of constituent materials, including the various electronic parts of the type noted above. Manufacturing of electronic products and logistics involved is very complicated due to the large number of parts involved. Most organizations will have multiple products at various stages of design, sourcing, and manufacturing, at any given time.

Due to the complexity of the process involved, production and forecasting changes and inefficiencies occur frequently in the manufacturing of such products. These changes and inefficiencies cause inventory imbalances including inventory excess and/or shortages of key parts at organizations that maintain inventories of such parts. Such organizations include Original Equipment Manufacturers (OEMs) or Contract Manufacturers (CMs), both of which are collectively referred to herein as organizations.

To address such inventory issues and to facilitate purchase and distribution, various systems and methods for inventory control and sourcing have been proposed. For instance, U.S. Pat. No. 6,324,522 to Peterson et al. discloses an electronic information network and process for inventory control and transfer for distributing items, especially industrial maintenance repair and operating (MRO) parts and supplies. The proposed process includes providing a plurality of vendors for selling the part, and an information network by which each vendor can communicate to the other vendors a current inventory quantity and a current price of the part the vendors has for sale. The process further establishes an agreement among the vendors regarding the price of the items to be sold, upon demand at a future point in time, up to the then current inventory quantity of the item at the then current price communicated over the information network.

The market for the purchase and distribution of electronic parts used in the manufacture of electronic products may be considered to be similar to a commodities market. This is because many parts in the electronic part market have become relatively generic in their design so that many parts from different part manufactures are interchangeable. In addition, some identical or substantially similar parts may also be available from multiple part manufacturers who compete on part attributes such as price. Because of the recognized part interchangeability, organizations are also apt to perform opportunistic procurement or disposal of key parts outside their well-established distribution channels in order to take advantage of favorable market conditions such as market price, or for other reasons.

To account for the recognized part interchangeability, a catalog or list of parts is maintained for each product by the product manufacturer. These lists are the result of product design and aid in part procurement and product manufacture. Product manufacturers also maintain general catalogs or lists of parts to organize inventory, manage part requirements, or for other purposes. All such lists of parts will be referred to hereinafter as “lists” or “catalogs” interchangeably.

For various business and technical reasons, organizations typically maintain part lists by internally assigned part numbers rather than actual manufacturer names and part numbers, such internal part numbers being assigned using a variety of schemes. Such internal part numbers are usually not self-describing and it is not obvious what manufacturers and manufacturer part numbers are meant by a particular internal part number. In many instances, internal part numbers are used to insulate a particular list or catalog from the constant change in the electronic part market.

In addition, the semiconductor industry is characterized by numerous market participants and complex business dealings. Organizations that do business with other organizations often consider organizations that compete with each other as business partners. Thus, part lists and catalogs are often shared between business partners, and between business partners' business partners. Consequently, by maintaining business partners' lists and catalogs using relatively obfuscating internal part numbers, the likelihood that privileged business information will inadvertently be given out inappropriately is substantially reduced.

While lists and catalogs serve to correlate each internal part number to a part number of the part manufacturer to a certain extent, they are very cumbersome to use. Moreover, as the number of electronic parts and their manufacturers continue to expand, cataloging of internal part numbers and correlating them to manufacturer part numbers becomes increasingly difficult. In addition, obtaining, maintaining, and updating information regarding interchangeability of electronic parts become an incredibly difficult and complex task. Furthermore, the information related to the internal part number's correlation to the manufacturer's part number and to interchangeable manufacturer part numbers must be updated to reflect changing market availability, updated technology, or for other reasons.

To address the complexity of maintaining and utilizing such lists or catalogs, an electronic sourcing system and method has also been proposed in U.S. Pat. Nos. 6,023,683 and 6,055,516, both issued to Johnson et al. The proposed electronic sourcing system includes a computer that maintains a catalog database of data including product information such as product identification and descriptive information relating to catalog items available from vendor product catalogs, and a means for building a requisition including at least one requisitioned item. Information at least partially identifying an item desired to be requisitioned is entered by a user, and utilized by a means for searching the database for catalog items matching that information and for selecting at least one catalog item located as a result of the search. Text describing the catalog items, and images of the items, may be viewed. Data identifying selected catalog items are communicated to the requisition building means, which generates a requisition including entries for items corresponding to the selected catalog items. The system checks the availability in one or more inventory locations of the corresponding desired catalog items, and generates one or more purchase orders for desired items from inventory locations stocking the items.

However, the proposed system of Johnson et al. still does not fully address the difficulties associated with purchasing and distributing parts in a commodities type market. In particular, the system of Johnson et al. does not significantly facilitate the cataloging of internal part numbers and correlating them to manufacturer part numbers. Furthermore, the proposed system also does not facilitate obtaining, maintaining and updating of information regarding interchangeability of parts.

Therefore, there exists an unfulfilled need for a system and method for facilitating the cataloging of internal part numbers and correlating them to manufacturer part numbers. Furthermore, there also exists an unfulfilled need for a system and method for facilitating the obtaining, maintaining and updating of information regarding interchangeability of parts.

### SUMMARY OF THE INVENTION

In the above regard, the present inventors recognized that simple exchange of part lists or catalogs presents limitations that impede efficiency and ease of use. In particular, list recipients must ascertain the manufacturers and manufacturer part numbers meant by each listed internal part number through arbitrary discovery processes which typically involve directly contacting the source of the list or catalog, and manual exchanging internal and external part number information. This undesirable method of obtaining information is exacerbated when a part list or catalog is presented to multiple business partners, and even more so when the list or catalog is passed on by the source's partners.

In view of the forgoing, the primary advantage of the present invention is in providing a system and method for facilitating the cataloging of internal part numbers and correlating them to manufacturer part numbers.

Another advantage of the present invention is in providing a system and method for facilitating the obtaining, maintaining and updating of information regarding interchangeability of parts.

Still another advantage of the present invention is in providing a system and method for automatically mapping manufacturer part numbers to internal part numbers and other manufacturer part numbers.

Yet another advantage of the present invention is in providing a system and method for saving unknown internal part numbers and automatically mapping the saved part numbers when a corresponding manufacturer part number becomes known.

Furthermore, another advantage of the present invention is in providing a system and method for retrieving correlated manufacturer part numbers from an internal part number.

These and other advantages are attained by a parts mapping system, a data storage media with computer executable instructions, and a method for mapping internal part numbers to manufacturer part numbers. In accordance with one embodiment of the present invention, the parts mapping system comprises an input device adapted to allow input of an internal part number and a correlated manufacturer part number, a database of internal part numbers and manufacturer part numbers correlated to one another, and a processor adapted to determine whether the inputted manufacturer part number is stored in the database and is correlated to the inputted internal part number. The processor is further adapted to store the inputted internal part number and the correlated manufacturer part number in the database if the inputted manufacturer part number is determined to be absent from the database.

In one embodiment, the parts mapping system is connected to a network to allow remote access thereof. In accordance with another embodiment, the processor is further adapted to generate a data set having at least one manufacturer part number stored in the database which is correlated to the inputted internal part number. The data set preferably includes plurality of manufacturer part numbers stored in the database which are correlated to a plurality of internal part numbers stored in the database, the plurality of internal part numbers being correlated to the at least one manufacturer part number.

In accordance with another embodiment, the processor of the parts mapping system is adapted to determine whether the inputted internal part number is present in the database, and the processor is further adapted to request input of a manufacturer part number correlated to the inputted internal part number if the inputted internal part number is absent from the database. In another embodiment, the processor further generates a data set having a plurality of manufacturer part numbers stored in the database which are correlated to a plurality of internal part numbers stored in the database, the plurality of internal part numbers being correlated to an inputted manufacturer part number inputted in response to the request.

In accordance with still another embodiment, the processor of the parts mapping system is adapted to determine whether the inputted internal part number is present in the database, and the processor is further adapted to generate a data set having at least one manufacturer part number stored in the database which is correlated to the inputted internal part number if the inputted internal part number is present in the database. In another embodiment, the parts mapping system further includes an inactive records database, wherein the processor further stores the inputted internal part number in the inactive records database if the inputted internal part number is absent from the database. Preferably, the processor further monitors subsequently inputted internal part numbers and manufacturer part numbers correlated thereto to determine if the inputted internal part number stored in the inactive records database is present, and removes the inputted internal part number from the inactive records database if the inputted internal part number is subsequently inputted with at least one correlated manufacturing part number.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a parts mapping system in accordance with the present invention which has been networked via the distributed network used in a parts market.

FIG. 2 is a detailed schematic illustration of a networked parts mapping system in accordance with one embodiment of the present invention.

FIG. 3 is an enlarged schematic view of the database in accordance with the present invention.

FIG. 4 is a flow diagram of a method for mapping internal part numbers to manufacturer part numbers in accordance with one embodiment of the present invention.

FIG. 5 is an expansion diagram which more clearly illustrates the resulting data sets of the method described above relative to FIG. 4.

FIG. 6 is a logical flow diagram illustrating the how the parts mapping system of FIG. 2 may be used and operated.

FIG. 7 is another logical flow diagram illustrating the how the parts mapping system of FIG. 2 may be used and operated.

FIG. 8 is a screen shot of a search toolbar page of a parts mapping system in accordance with the present invention that is implemented as a website.

FIG. 9 is a screen shot of a map request page of a parts mapping system implemented as a website.

FIG. 10 is a screen shot of a data set results page of the parts mapping system implemented as a website.

FIG. 11 is a screen shot of a main map page of the parts mapping system implemented as a website.

FIG. 12 is a screen shot of a map results page of the parts mapping system implemented as a website.

FIG. 13 is a screen shot of a mapping page of the parts mapping system implemented as a website.

### DETAILED DESCRIPTION OF THE PREFERRED EMBODIMENT

As will be described in further detail hereinbelow, the present invention provides a system and method for facilitating the cataloguing of internal part numbers and correlating the internal part numbers to manufacturer's part numbers so that obtaining, maintaining, and updating of information regarding interchangeability of parts is greatly facilitated. The system and method in accordance with the present invention is especially useful in facilitating transactions between market participants such as sellers, and buyers, etc. for electronic parts which are used to manufacture electronic products as previously described due to the interchangeability of electronic parts. However, it should further be noted that the present invention may be applied to other industries in which broad interchangeability of parts exists so that the market for transacting in such parts is similar to a commodities market.

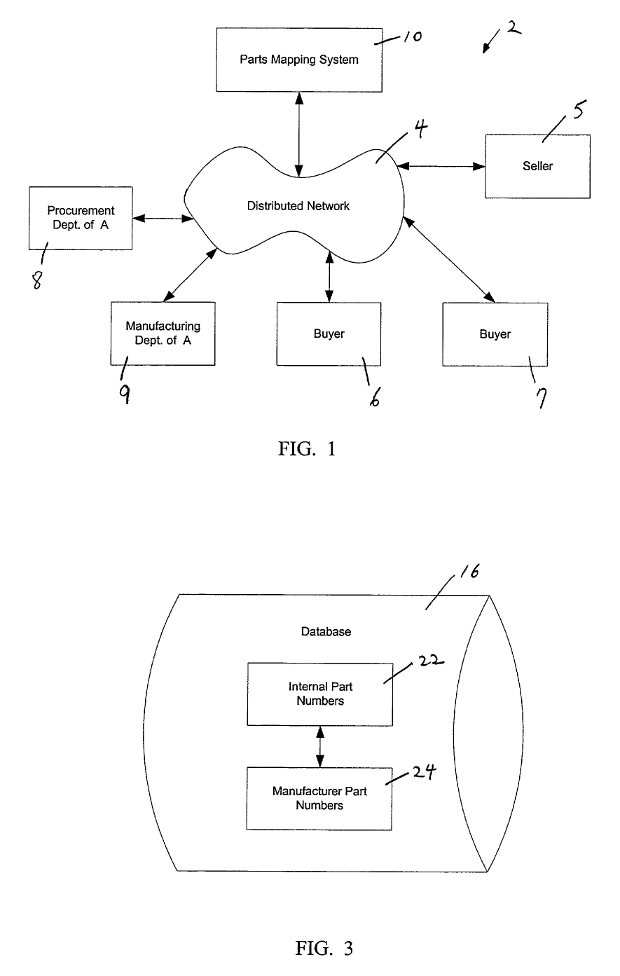

FIG. 1 illustrates a parts mapping system 10 in accordance with the present invention which has been networked via the distributed network 4 used in a parts market 2. It should be appreciated by one of ordinary skill in the art that the distributed network 4 can be any type of a communications network such as the Internet, local area network (LAN), a wide area network (WAN), direct computer connections, or the like.

As can be seen, the parts market 2 includes various participants that can access and use the parts mapping system 10 through the distributed network 4. For instance, in the illustrated example of FIG. 1, the participants include seller 5 that seeks to sell various parts in the parts market 2, as well as buyer 6 and buyer 7 that are seeking to purchase various parts through the parts market 2. In this regard, in the illustrated example, the participants are remotely located and have remote access to the parts mapping system 10.

In addition, it should be noted that the participants of the parts market 2, and correspondingly, the users of the parts mapping system 10, need not be in different organizations or companies. For instance, in the illustrated embodiment, a procurement department 8 of organization A can access the parts mapping system 10 to determine whether it can obtain needed parts from inventory of the manufacturing department 9 of the same organization A. Therefore, it should be clear that the present invention may be utilized by any interested participants desiring transaction related information regarding parts in the parts market 2, such participants including buyers, sellers and departments of organizations.

The communication between the parts mapping system 10, and participants such as seller 5 and buyers 6 and 7 may be established via the distributed network 4 using any type of communication hardware and protocols which are already well known in the art. For instance, such communication can be accomplished over electric cable, fiberoptic cable, or any other cable, or in a wireless manner using radio frequency, infrared, or other technologies.

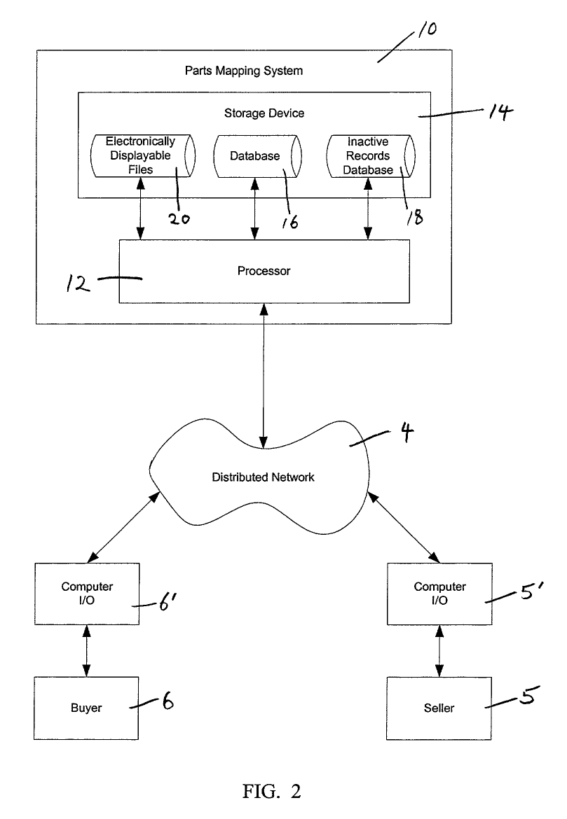

FIG. 2 illustrates in further detail, the parts mapping system 10 in accordance with one embodiment of the present invention, which again, is shown networked to the distributed network 4. As can be seen, the parts mapping system 10 is made accessible via distributed network 4, thus allowing seller 5 and buyer 6 to access the parts mapping system 10 through input and output devices such as computers 5′ and 6′ respectively.

In the illustrated embodiment, the parts mapping system 10 includes a processor 12 and a storage device 14. The storage device 14 of the illustrated embodiment includes a database 16 having internal part numbers and manufacturer part numbers correlated to one another, and an inactive records database 18, the details of which is described in further detail below. The storage device 14 also includes electronically displayable files 20 that can be displayed as user interfaces for allowing participants such as seller 5 and buyer 6 to interface with the parts mapping system 10. Through such files 20, the participants can provide inputs to the parts mapping system 10 and receive outputs from the parts mapping system 10. In this regard, the processor 12 controls and maintains the storage device 14 in the manner further described below, receives and appropriately processes inputs and queries from the participants, and further provides a data set of manufacturer part numbers.

FIG. 3 shows an enlarged schematic illustration of database 16 of FIG. 2. As can be seen, the database 16 includes internal part numbers 22 and manufacturer part numbers 24. It is important to note that the internal part numbers 22 are correlated to the manufacturer part numbers 24, and vice versa, as shown. As used herein, the term “correlated” and derivations thereof, refer to the fact that each of the internal part numbers that are stored in the database 16 are associated or mapped to one or more of the manufacturer part numbers 24 stored in the database 16.

As previously noted, for various business and technical reasons, organizations typically maintain part lists by internal part numbers (i.e. internal to the organization) rather than actual manufacturer part numbers. Because of the interchangeability of parts, different parts from different manufacturers (i.e. parts having different manufacturer part numbers) can be used by an organization to perform functions of the part which is identified by the internal part number. In a likewise manner, each of the manufacturer part numbers 24 stored in the database 16 are associated to one or more internal part numbers 22 stored in the database 16. Thus, the internal part numbers 22 and the manufacturer part numbers 24 in the database 16 in accordance with the present invention are correlated, or in other words, mapped to one another.

In the above regard, lists and catalogs that identify internal part numbers and correlated manufacturer part numbers for one or more parts can be entered into the database 16 of the parts mapping system 10. Lists and catalogs can be from multiple sources, such as various organizations, companies or company business units. The data may also optionally be associated with their source organizations. Furthermore, the database 16 may be initially populated with internal part numbers and manufacturer part numbers correlated thereto. Such part numbers may be inserted into the database 16 of the parts mapping system 10 by manual entry by a data entry clerk, or through import of a computer file in a specified format (e.g. Microsoft Excel) through a system component built to automate file importation.

The parts mapping system 10 as shown in FIG. 2 may be advantageously used to retrieve all of the manufacturer part numbers that are associated with a particular internal part number. As described hereinbelow, the processor 12 of the parts mapping system 10 is adapted to determine whether an inputted manufacturer and/or internal part number as inputted by the participants in, for instance, a query, is stored in the database 16. The processor 12 is further adapted to generate a data set of all the manufacturer part numbers stored in the database 16 that are correlated to the inputted manufacturer and/or internal part number. Thus, by submitting a query with a single part number to the parts mapping system 10, whether it be an internal part number or a manufacturer part number, the participant such as the seller 5 and/or buyer 6 can obtain manufacturer part numbers that identify interchangeable parts that can be sold, bought, or otherwise transacted.

In the above regard, the preferred embodiment of the parts mapping system 10 incorporates a unique and novel method of mapping that generates a data set of manufacturer part numbers stored in the database 16 from the internal and/or manufacturer part number inputted by the participant such as the seller 5 and/or buyer 6. As will be evident from the discussion below, the method of mapping in accordance with the present invention significantly increases the likelihood of identifying all the interchangeable manufacturer part numbers that are stored in the database 16.

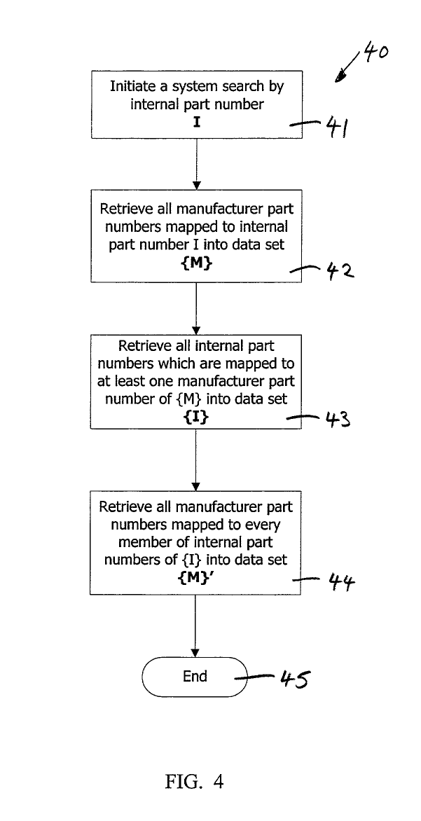

FIG. 4 is a flow diagram 40 illustrating a method for mapping internal part numbers to manufacturer part numbers in accordance with one embodiment of the present invention that may be used by the processor 12 of FIG. 2. In this regard, FIGS. 2 and 4 are discussed together herein for clarity. The method for mapping internal part numbers to manufacturer part numbers illustrated by the flow diagram 40 may be used to search the database 16, and generate a data set having all the manufacturer part numbers correlated to the inputted internal part number.

In particular, a participant such as the seller 5 or the buyer 6 initiates a search within the parts mapping system 10 to search for an internal part number I in step 41. As previously noted, such a search may be initiated using computers 5′ and 6′ which provides a user interface stored in the electronically displayable files 20 of the parts mapping system 10 via the distributed network 4.

The processor 12 then searches the database 16 to retrieve all manufacturer part numbers that are correlated (i.e. mapped) to the inputted internal part number I in step 42, all the retrieved manufacturer part numbers defining a data set {M}. In step 43, the processor 12 then retrieves a plurality of internal part numbers stored in the database 16 which are correlated to at least one manufacturer part number in the data set {M}, the retrieved plurality of internal part numbers defining a data set {I}. The processor 12 then retrieves a plurality of manufacturer part numbers that are correlated to each of the plurality of internal part numbers defining data set {I} in step 44, the retrieved plurality of manufacturer part numbers defining a data set {M}′. The method of mapping ends in step 45.

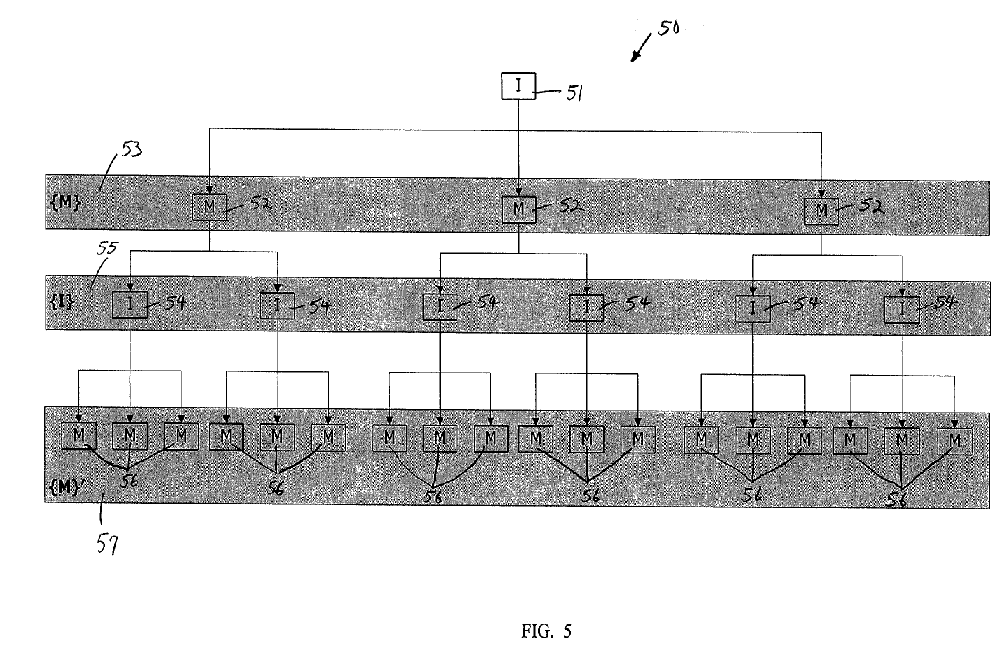

FIG. 5 is an expansion diagram 50 which more clearly illustrates the resulting data sets of the method described above relative to FIG. 4. In particular, a system search is initiated by inputting internal part number I which is indicated by number 51. Then the processor 12 searches and retrieves a plurality of manufacturer part numbers M indicated by numeral 52 from database 16 that are correlated to the inputted internal part number I which define the data set {M} indicated by numeral 53. The manufacturer part numbers 52 defining the data set {M} 53 are further expanded by the processor 12 so that plurality of internal part numbers 54 correlated thereto are retrieved from the database 16 to define data set {I} indicated by numeral 55. Then, each of the plurality of internal part numbers 54 of the data set {I} 55 are further expanded by the processor 12 to retrieve all the manufacturer part numbers M indicated by numeral 56 stored in the database 16 that are correlated to the retrieved internal part numbers 54 of the data set {I} 55. The plurality of manufacturer part numbers 56 comprise data set {M}′ indicated by numeral 57 represents all of the manufacturer part numbers stored in the database 16 which are correlated to the inputted internal part number I 51.

The method described above can be concisely represented by:

I→{M}→{I}→{M}′

where internal part number I is translated to a data set {M} of all mapped manufacturer part numbers. Data set {M} is then translated to a data set {I} of all internal part numbers in the system, where the retrieved internal part numbers are correlated to at least one member of {M}. Finally, {I} is translated back to a data set {M}′ of all manufacturer part numbers mapped to the internal part numbers of data set {I}.

The generated data set {M}′ which is a conglomerated set of search results may then be outputted by the processor 12 to the participant such as buyer 6 and/or seller 5 that initiated the query. As can be appreciated, in contrast with the prior art in which only directly correlated manufacturer part numbers are outputted in response to a search (i.e. analogous to data set {M}), the method of mapping in accordance with the present invention further expands the data set to improve the likelihood of obtaining all manufacturer numbers stored in the database 16 that are correlated to the inputted internal part number I. In this way, the scope of data retrieval is widened as far as possible and extends to the limits of part interchangeability as designated across source catalogs and lists that serve as the basis for the internal part numbers and manufacturer part numbers correlated thereto.

It should be noted that whereas in the illustrated embodiments of FIGS. 4 and 5, the search was initiated by inputting an internal part number, in other embodiments, the search may further be initiated based on input of a manufacturer number as well. In such instances, the parts mapping system would search for the inputted manufacturer number in the database for internal part numbers correlated to the inputted manufacturer part number. The retrieved internal part numbers are further expanded into a data in a manner similar to that described above to retrieve all of the manufacturer part numbers stored in the database that are correlated to the retrieved internal part numbers.

Referring again to FIG. 2, the parts mapping system 10 is also adapted to facilitate the cataloguing, maintaining, and updating of information so that the usefulness of the parts mapping system 10 is maintained. In this regard, the electronically displayable files 20 may include various files that may be used by the processor 12 to interface with the participants in performing various other functions as well.

For instance, in the case where an internal part number and the corresponding manufacturer's part number are inputted by the participant, and the processor 12 determines that either the internal part number or the manufacturer part number is absent from the database 16, the processor 12 updates the database 16 by storing the inputted internal part number and the manufacturer part number correlated thereto in the database 16. In this manner, the parts mapping system 10 automatically updates the database 16 so that the internal part numbers 22 and correlated manufacturer part numbers 24 are retrievably stored in the database 16 and the total number of part numbers in the database 16 are continually expanded. Thus, corresponding part mappings that were not already known to the system are automatically created for future use.

In the instance where an internal part number is inputted by a participant and is determined to be absent from the database 16 by the processor 12, the processor 12 stores the inputted internal part number in the inactive records database 18 as an inactive internal part number. Processor 12 then monitors subsequently inputted internal part numbers and manufacturer part numbers correlated thereto to determine if the inactive internal part number stored in the inactive records database 18 is present. If the inactive internal part number is present and is also inputted together with a correlated manufacturing part number, the subsequently inputted internal part number and manufacturer part number are stored in the database 16, and the inactive internal part number is deleted from the inactive records database 18. If no such corresponding manufacturer part number is provided, a file from the electronically displayable files 20 may be displayed to the participant that requests the input of the corresponding manufacturer part number.

The storing of inputted internal part numbers in the inactive records database 18 can be used especially advantageously in the context where there is an instruction or request associated with the inputting of the internal part number. For instance, buyer 6 may have inputted the internal part number to check on availability and/or pricing of the particular part. However, because the internal part number was not found in the database 16, corresponding manufacturer part numbers and information such as price and availability associated thereto cannot be provided to the buyer 6 that submitted the query.

By storing the inputted internal part number in the inactive records database 18, a record is made to allow monitoring of subsequent entries into the database 16 for mapping the inactive internal part number. Such subsequent entry of an internal part number and a corresponding manufacturer part number by buyer 6 or any other participant, allows the mapping of the inactive internal part number into the database 16 so that the initially requested information, such as availability and/or pricing noted above, can be provided to the buyer 6. The internal part number can then be deleted from the inactive records database 18.

Thus, when queries are provided using internal part numbers for which no mappings are known to the parts mapping system 10 yet, the parts mapping system 10 stores the queries using unknown internal part number anyway as an inactive internal part number in the inactive records database 18. The queries remain inactive for the purpose of system processing until appropriate part mapping information is entered into the parts mapping system 10, at which point the system automatically processes the query associated to the stored inactive internal part number. In this manner, the present invention provides auto-activation of previously inactive query that used previously unknown internal part numbers. Of course, the above feature is equally applicable to inputted manufacturer part numbers which are not correlated to any other part number stored in the database 16, the discussion of which is omitted to avoid repetition.

The above described parts mapping system 10 of the present invention can be implemented as a program embedded in a computer, dedicated parts mapping system, or the like. More specifically, the parts mapping system 10 may be implemented as a separate programmed general purpose computer having a communication device, a special purpose computer, a programmed microprocessor or a microcontroller and peripheral integrated circuit element, an ASIC or other integrated circuit, a digital signal processor, a hardwired or electronic logic circuit such as a discrete element circuit, a programmable logic device, or the like. Additionally, the input/output devices 5′ and 6′ can include a keyboard, mouse, speech to text converter, or the like for allowing participants to input data. In addition, a display device may be provided such as a computer monitor, a display on a PDA, or any other device capable of displaying information to the participants using the parts mapping system 10.

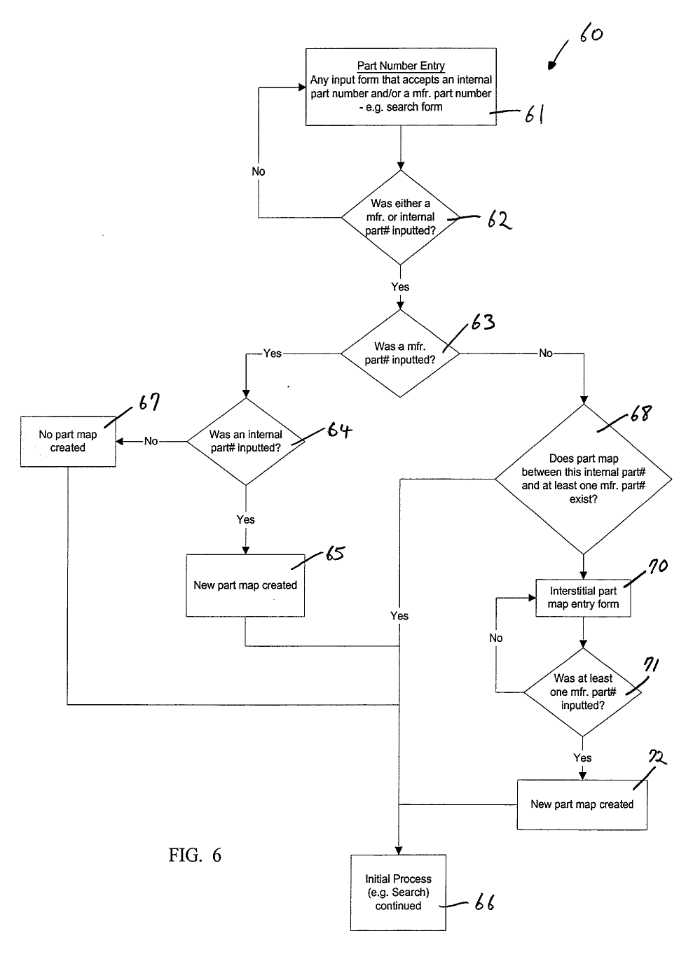

FIG. 6 illustrates a logical flow diagram 60 that illustrates one example of how the parts mapping system 10 of FIG. 2 may be used and operated, elements of both figures being referred to herein. A user interface stored in the electronically displayable files 20 of the storage device 14 is provided to a participant such as the seller 5 or buyer 6 to allow inputting of an internal part number and/or manufacturer part number in step 61. The processor 12 then determines whether a manufacturer part number or internal part number was entered in step 62. The processor then determines if the inputted part number was a manufacturer part number in step 63. If the manufacturer part number was entered, the processor 12 further determines whether an internal part number was entered with the manufacturer part number in step 64. If an internal part number was entered, a new part map is created in step 65, the part map establishing the correlation between the inputted internal part number and the inputted manufacturer part number. The correlated part numbers are stored in the database 16 and the initiated process, such as a part number search, is continued in step 66. If a correlated internal part number was not inputted, no part map is created as indicated in 67 and the initial process of searching is continued in step 66.

Referring again to step 63, if a manufacturer part number was not inputted, the processor 12 determines whether the inputted internal part number is present in the database 16 and correlated to at least one manufacturer part number in step 68. If such correlated manufacturer part number is present in database 16, the initial process of searching is continued in step 66. However, if no correlated manufacturer part number is present in the database 16, an interstitial part map entry form is provided to the participant in step 70 which requests the entry of a manufacturer part number which correlates to the inputted internal part number. The interstitial part map entry form may be stored in electronically displayable files 20 of the storage device 14 as a user interface and called up by the processor 12 as needed. The processor 12 then determines whether the requested manufacturer part number is inputted by the participant in step 71. When the requested manufacturer part number is inputted, a new part map is created in step 72 for addition to database 16. Thus, in the above described manner, the part mapping system may be operated to automatically update and add to the plurality of internal part numbers and plurality of manufacturer part numbers correlated thereto that are stored in the database 16.

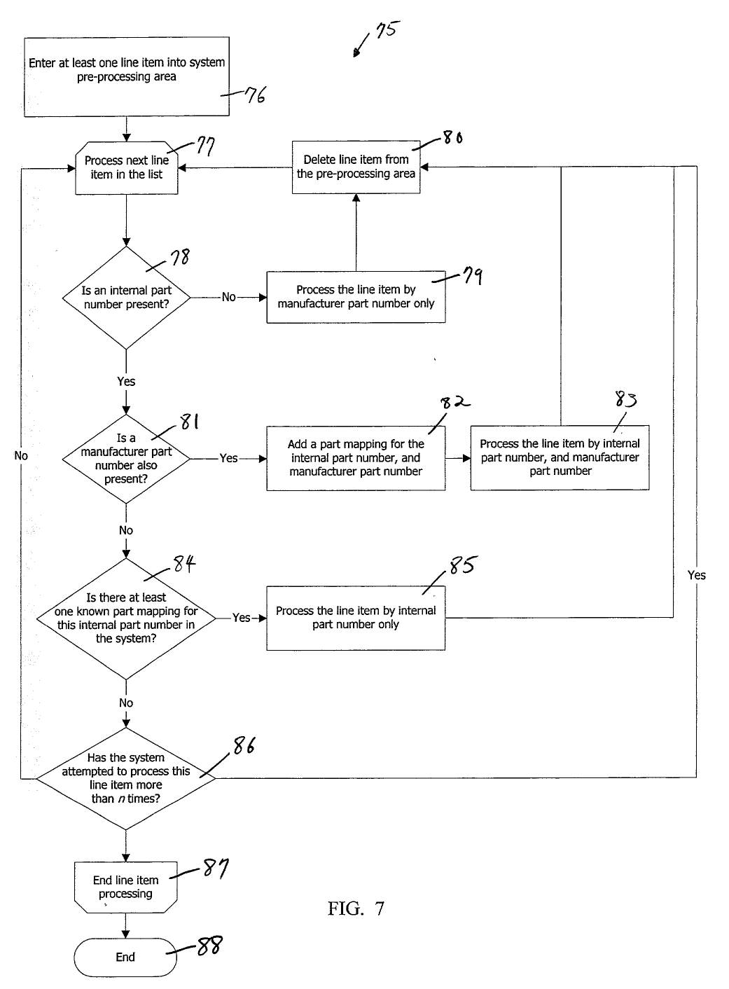

FIG. 7 illustrates another alternative logical flow diagram 75 of how the parts mapping system 10 of FIG. 2 may be used and operated in the context of the parts market 2 shown in FIG. 1, elements of these figures being referred to herein. In particular, the logical flow diagram 75 is especially useful where the parts mapping system 10 is incorporated into a parts market 2 that allows the participants such as seller 5 and buyer 6 to transact. For instance, such a parts market 2 would allow selling and purchasing of various parts by the participants that may be from different organizations or from different departments of the same organization.

In step 76, an internal part number and/or manufacturer part number is entered as a line item in a preprocessing area, which again, may be implemented as a user interface stored in the electronically displayable files 20 of the parts mapping system 10 shown in FIG. 2. Each line item has an internal part number and/or manufacturer part number that is associated to an instruction regarding supply or demand for a particular part, for example, instructions to sell and/or buy, instructions to obtain parts information such as price and availability, etc. Each line item is processed in step 77 by the processor 12 and the processor 12 determines whether an internal part number is present, i.e. inputted in step 78. If an internal part was not inputted, the processor 12 processes the line item by the manufacturer part number only in step 79.

The processing may be that as described above relative to FIGS. 4 and 5 in which the data set having a plurality of manufacturer part numbers is generated. The processed manufacturer part number and the line item corresponding thereto are deleted from the preprocessing area in step 80.

If an internal part number was determined to be present in step 78, the processor determines whether a manufacturer part number is also present in step 81. If such a manufacturing part number was also present, the processor 12 adds the part mapping for the inputted internal part number and the correlated manufacturer part number into the database 16 of the storage device 14 in step 82 so that the internal part number and the manufacturer part number correlated thereto are stored in the database 16 for future retrieval. Then, the line item is processed in step 83 and the line item is deleted from the preprocessing area in step 80.

If a manufacturer part number was not inputted in step 76 as determined by step 81, the processor searches the database 16 to determine whether at least one known part mapping for the inputted internal part number exists in the database 16 in step 84. In other words, the processor determines whether the inputted internal part number is stored in the database 16 and is correlated to at least one manufacturer part number also stored in the database 16. If such known part mapping exists, the line item is processed using the internal part number only in step 85.

If no such mapping exists, the processor 12 determines whether the line item has been attempted to be processed more than a predetermined number of times in step 86. If the parts mapping system 10 has attempted to process the line item more than the predetermined number of times, the line item is deleted from the preprocessing area in step 80. Otherwise, the above noted steps are repeated for each line item. This feature is particularly suited for line items that cannot be processed because the inputted internal part number does not have a correlated manufacturer part number stored in the database 16. In such instances, the inputted internal part number may be stored in the inactive records database 18 as an inactive internal part number. Then, subsequently inputted internal part numbers that are correlated to a manufacturing part number may be monitored to determine if the inactive internal part number is present. When a subsequently inputted internal part number that is inputted with a correlated manufacturing part number is present, the part numbers are stored in the database 16. The parts mapping system can then retrieve the line item and process the line item as originally intended. Once all the line items are processed, the processing is ended in step 87, the results of the processing may be displayed, for instance in the termination step 88, to the participant that entered the line items in step 76.

Whereas particular logic and method of using and operating the parts mappings system 10 has been discussed above, it should be noted that the above discussed logical flow diagrams shown in FIGS. 6 and 7 are examples only and other variations and logic may be used in other embodiments.

The parts mapping system 10 in accordance with the present invention may be advantageously implemented as a website accessible via the distributed network 4 referred to in FIG. 1 which corresponds, for example, to the Internet, also known as the worldwide web. Such an implementation of the parts mapping system 10 allows remotely located participants to access the parts mapping system 10 using an input/output device such as computers 5′ and 6′ shown in FIG. 2 that are connected to the Internet.

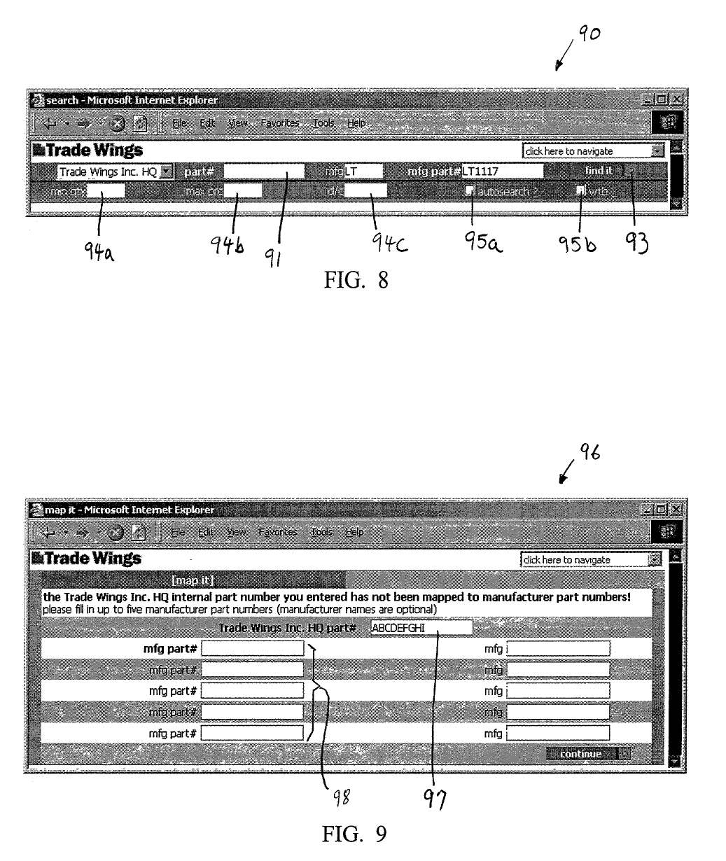

One specific example of web implementation of the parts mapping system 10 of FIG. 2 in accordance with the present invention is shown in FIGS. 8 to 13 which are various screen shots of the web pages for Trade Wings Inc. It should be noted that Trade Wings Inc. brokers the purchase and sale of surplus or shortage semiconductor and electrical components for OEM, CEM, and other organizations in the semiconductor/electronics industry. In view of the previously described commodity status of such electronic parts, Trade Wings Inc. has implemented the parts mapping system 10 present invention in a website so that various participants such as sellers and/or buyers can efficiently transact regarding such parts, thereby providing a more efficient parts market 2 represented in FIG. 1. Of course, the design and implementation of the web pages and websites using various tools including computer programming language such as HTML and JAVA® are well known in the art and need not be discussed in detail here.

In regards to the various screen shots shown in FIGS. 8 to 13 described below, it should be noted that such interfaces are provided as an example only and may be stored in the electronically displayable files 20 of the storage device 14 described above relative to FIG. 2. Moreover, whereas the illustrated embodiments have been viewed using Microsoft Internet Explorer®, other browsers such as Netscape® may also be used.

FIG. 8 illustrates a search toolbar page 90 in which a participant such as seller 5 or buyer 6 can check for part availability information by entering an internal part number in field 91, or by entering a manufacturer part number in field 92. Upon entry of the part number information, “find it” button 93 may be pressed so that the parts mapping system in accordance with the present invention, such as that shown in FIG. 2, can generate a database in the manner described above.

In addition, other parameters may also be entered such as the minimum quantity required in field 94a, the maximum price in field 94b, etc. In addition, date codes may be entered in field 94c. Furthermore, additional features may be provided and selected by the participants on the search toolbar page 90 including “autosearch” feature 95a, and “want to buy” or “wtb” feature 95b. For instance, checking the “autosearch” feature 95a has no effect on the part search itself, but causes periodic re-run of the part search for the next 24 hours. When new results are found that match the search query, the participant requesting the search may be notified immediately via e-mail. In this regard, the parts mapping system may be provided with an additional feature which keeps track of past information viewed by the participant so that the participant is not inundated with redundant e-mails that cover the same search results. Checking the “want to buy” feature 95b causes automatic entry of the inputted part number and the participant's information in a separate page (not shown) that may be readily viewed by sellers of the specific part or an interchangeable part which is desired by the participant.

FIG. 9 illustrates a map request page 96 which is provided to the participant, if an internal part number is searched and is found to be absent from the database 16 of the parts mapping system 10. As can be seen, the inputted internal part number is shown in field 97, and map request page 96 requests the entry of one or more corresponding manufacturing part numbers in the plurality of fields 98.

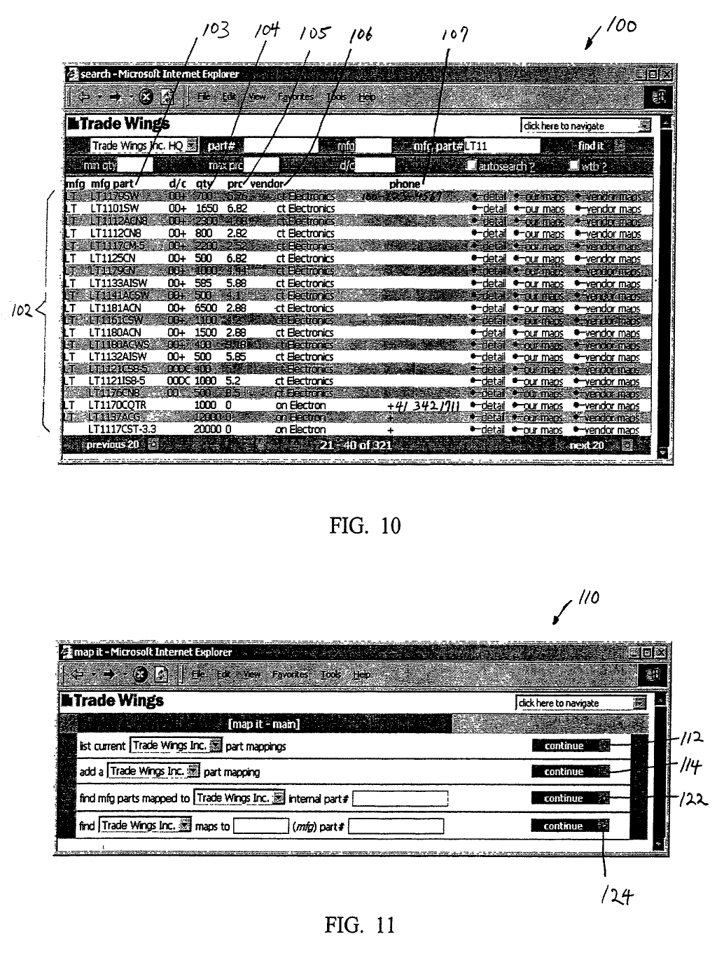

FIG. 10 illustrates an exemplary output of a data set generated using the parts mapping system 10 and the method in accordance with the present invention as discussed above. In particular, the data set results page 100 shows a portion of the data set 102 generated by the processor 12 in response to an inputted manufacturing part number. All of the noted parts are interchangeable with one another so that a participant can view the available products, the respective quantities available, and their price, to allow the participant to transact, in this case buy, a desired part. In this regard, the manufacturer part number is displayed in column 103, the available quantity is displayed in column 104, and the price is displayed in column 105. In addition, the vendor is identified in column 106 as well as the contact information in column 107 so that the participant can initiate direct contact with the identified vendor if desired. Of course, the data set results page 100 is merely exemplary and the generated data set may be displayed in any appropriate format. In addition, additional links providing further detail regarding a particular manufacturer part number may also be provided in the manner shown. Thus, by applying a search for interchangeable manufacturer part numbers correlated to the inputted internal part number in the manner previously described relative to FIGS. 4 and 5, superficially hidden matches are uncovered thereby providing opportunities for Trade Wings Inc. to facilitate execution of part transactions.

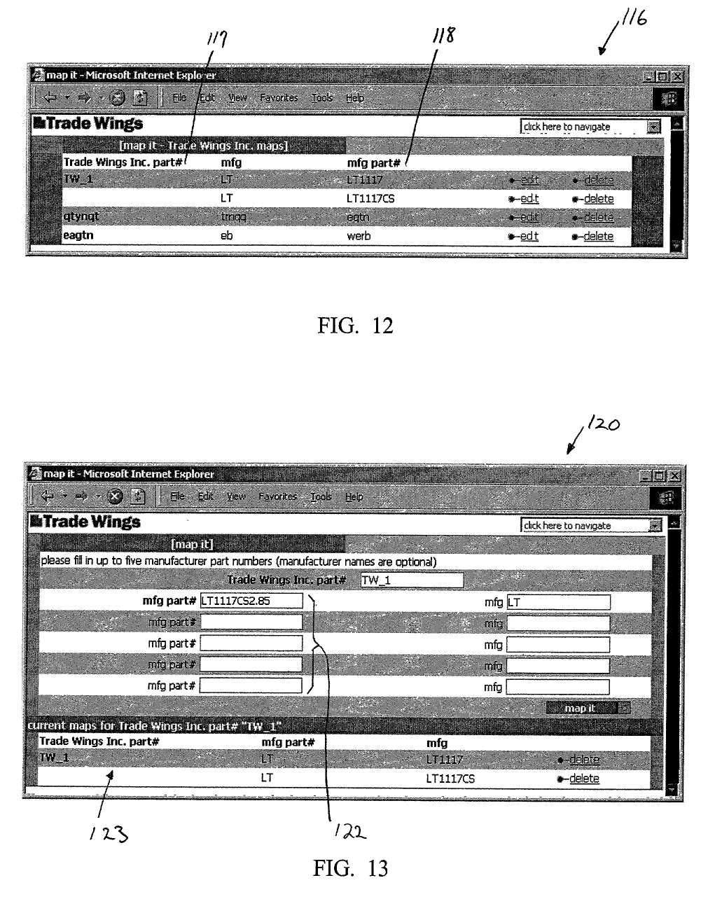

The extensive database 16 which stores the internal part numbers and manufacturer part numbers correlated thereto allows the participant such as a buyer and/or seller to access mapping information to view various contents of the database 16 in various ways. In particular, the main map page 110 shown in FIG. 11 allows the participant to list, add, or find mappings. For instance, current part mappings for a particular organization can be viewed by clicking on button 112 which results in the display of mapping results page 116 shown in FIG. 12. As can be seen, Trade Wings Inc. internal part number is displayed in column 117 while the correlated manufacturer part numbers are displayed in column 118.

Referring again to FIG. 11, additional Trade Wings Inc. part mapping may be added to the database 16 by clicking on button 114 which causes the display of mapping page 120 of FIG. 13 which allows entry of correlated manufacturer part numbers in fields 122. In addition, the mapping page 120 of FIG. 13 also displays current maps stored for the particular part number in the map section 123.

Referring again to the menu page 110 of FIG. 11, manufacturer parts which are mapped to Trade Wings Inc. internal part number may be displayed by clicking on button 122, while Trade Wings Inc. maps that are correlated to a user inputted manufacturer part number may be displayed by clicking on button 124 of the menu page 110.

Thus, Trade Wings, Inc. has implemented the parts mapping system in accordance with the present invention via the Internet that provides a unique combination of capabilities relating to the performance of common market activities, using internal part numbers and manufacture part numbers from a collection of part lists and catalogs from multiple sources. In the above described manner, the parts mapping system and method described allows for the use of internal and/or manufacturer part numbers, such generic part numbers describing one or more interchangeable physical commodities, to be used to perform various inquiries related to availability, demand, and historical activity of the commodity across catalogs from various sources. The parts mapping system provides outputs to such inquiries by performing certain cross-referencing operations to part numbers used in inquiries in order to widen the scope of the inquiry as much as appropriate.

Lastly, the disclosed systems and methods can be readily implemented as software executed on a programmed general purpose computer, a special purpose computer, a microprocessor and associated communications equipment, or the like noted above. Furthermore, the disclosed method may be readily implemented in software using object or object-oriented software development environments that provide portable source code that can be used on a variety of computers, work stations, or modem hardware and/or software platforms. Thus, the present invention may be implemented in a hardware and/or software using any known later developed systems or structures, devices and/or software by those of ordinary skill in the applicable art from the functional description provided herein and with a general basic knowledge of the computer and telecommunications arts.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. A parts mapping system for mapping internal part numbers to manufacturer part numbers comprising:
an input device adapted to allow input of an internal part number and a correlated manufacturer part number;
a database of internal part numbers and manufacturer part numbers correlated to one another; and
a processor adapted to determine whether said inputted manufacturer part number is stored in said database and is correlated to said inputted internal part number, said processor being further adapted to store said inputted internal part number and said correlated manufacturer part number in said database if said inputted manufacturer part number is determined to be absent from said database.

2. The system of claim 1, wherein said parts mapping system is connected to a network to allow remote access thereof.

3. The system of claim 1, wherein said processor is further adapted to generate a data set having at least one manufacturer part number stored in said database which is correlated to said inputted internal part number.

4. The system of claim 3, wherein said data set includes plurality of manufacturer part numbers stored in said database which are correlated to a plurality of internal part numbers stored in said database, said plurality of internal part numbers being correlated to said at least one manufacturer part number.

5. A parts mapping system for mapping internal part numbers to manufacturer part numbers comprising:
an input device adapted to allow input of an internal part number;
a database of internal part numbers and manufacturer part numbers correlated to one another; and
a processor adapted to determine whether said inputted internal part number is present in said database, said processor being further adapted to request input of a manufacturer part number correlated to said inputted internal part number if said inputted internal part number is absent from said database.

6. The system of claim 5, wherein said parts mapping system is connected to a network to allow remote access thereof.

7. The system of claim 5, wherein said processor further generates a data set having at least one manufacturer part number stored in said database which is correlated to said inputted internal part number if said inputted internal part number is present in said database.

8. The system of claim 7, wherein said data set includes a plurality of manufacturer part numbers stored in said database which are correlated to a plurality of internal part numbers stored in said database, said plurality of internal part numbers being correlated to said at least one manufacturer part number that is correlated to said inputted internal part number.

9. The system of claim 5, wherein said processor further generates a data set having a plurality of manufacturer part numbers stored in said database which are correlated to a plurality of internal part numbers stored in said database, said plurality of internal part numbers being correlated to an inputted manufacturer part number inputted in response to said request.

10. A parts mapping system for mapping internal part numbers to manufacturer part numbers comprising:
an input device adapted to allow input of an internal part number;
a database of internal part numbers and manufacturer part numbers correlated to one another; and
a processor adapted to determine whether said inputted internal part number is present in said database, said processor being adapted to generate a data set having at least one manufacturer part number stored in said database which is correlated to said inputted internal part number if said inputted internal part number is present in said database.

11. The system of claim 10, wherein said parts mapping system is connected to a network to allow remote access thereof.

12. The system of claim 10, wherein said generated data set includes a plurality of manufacturer part numbers stored in said database which are correlated to a plurality of internal part numbers stored in said database, said plurality of internal part numbers being correlated to said at least one manufacturer part number that is correlated to said inputted internal part number.

13. The system of claim 10, further including an inactive records database, wherein said processor further stores said inputted internal part number in said inactive records database if said inputted internal part number is absent from said database.

14. The system of claim 13, wherein said processor further monitors subsequently inputted internal part numbers and manufacturer part numbers correlated thereto to determine if said inputted internal part number stored in said inactive records database is present.

15. The system of claim 14, wherein said generated data set includes a plurality of manufacturer part numbers stored in said database which are correlated to a plurality of internal part numbers stored in said database, said plurality of internal part numbers being correlated to said at least one manufacturer part number that is correlated to said inputted internal part number.

16. The system of claim 14, wherein said processor further removes said inputted internal part number from said inactive records database if said inputted internal part number is subsequently inputted with at least one correlated manufacturing part number.

17. A method for mapping internal part numbers to manufacturer part numbers comprising the steps of:
providing a database of internal part numbers and manufacturer part numbers correlated to one another;
inputting an internal part number and a correlated manufacturer part number;
determining whether said inputted manufacturer part number is present in said database and is correlated to said inputted internal part number; and
storing said inputted part number and said correlated manufacturer part number in said database if said inputted manufacturer part number is determined to be absent from said database.

18. The method of claim 17, further including the step of generating a data set having at least one manufacturer part number stored in said database which is correlated to said inputted internal part number.

19. The method of claim 18, wherein said data set includes a plurality of manufacturer part numbers stored in said database which are correlated to a plurality of internal part numbers stored in said database, said plurality of internal part numbers being correlated to said inputted manufacturer part number.

20. A method mapping internal part numbers to manufacturer part numbers comprising the steps of:
providing a database of internal part numbers and manufacturer part numbers correlated to one another;
inputting an internal part number;
determining whether said inputted internal part number is present in said database; and
requesting input of a manufacturer part number correlated to said inputted internal part number, and storing said inputted internal part number and inputted manufacturer part number correlated to said inputted internal part number into said database if said inputted part number is absent from said database.

21. The method of claim 20, further including the step of generating a data set having at least one manufacturer part number stored in said database which is correlated to said inputted internal part number if said inputted internal part number is present in said database.

22. The method of claim 21, wherein said data set includes a plurality of manufacturer part numbers stored in said database which are correlated to a plurality of internal part numbers stored in said database, said plurality of internal part numbers being correlated to said at least one manufacturer part number that is correlated to said inputted internal part number.

23. The method of claim 20, further including the step of inputting a manufacturer part number correlated to said inputted internal part number, in response to said request.

24. The method of claim 23, further including the step of generating a data set having a plurality of manufacturer part numbers stored in said database which are correlated to a plurality of internal part numbers stored in said database, said plurality of internal part numbers being correlated to said inputted manufacturer part number.

25. A method mapping internal part numbers to manufacturer part numbers comprising the steps of:
providing a database of internal part numbers and manufacturer part numbers correlated to one another;
inputting at least an internal part number;
determining whether said inputted internal part number is present in said database and is correlated to at least one manufacturer part number; and
generating a data set having at least one manufacturer part number stored in said database which is correlated to said inputted internal part number if said inputted internal part number is present in said database.

26. The method of claim 25, further including the step of outputting said generated data set.

27. The method of claim 25, wherein said generated data set includes a plurality of manufacturer part numbers stored in said database which are correlated to a plurality of internal part numbers stored in said database, said plurality of internal part numbers being correlated to said at least one manufacturer part number that is correlated to said inputted internal part number.

28. The method of claim 25, further including the step of storing said inputted internal part number in an inactive records database if said inputted internal part number is absent from said database.

29. The method of claim 28, further including the step of monitoring subsequently inputted internal part numbers and manufacturer part numbers correlated thereto to determine if said inputted internal part number stored in said inactive records database is present.

30. The method of claim 29, wherein said generated data set includes a plurality of manufacturer part numbers stored in said database which are correlated to a plurality of internal part numbers stored in said database, said plurality of internal part numbers being correlated to said at least one manufacturer part number that is correlated to said inputted internal part number.

31. The method of claim 29, further including the step of removing said inputted internal part number from said inactive records database if said inputted internal part number is subsequently inputted with at least one correlated manufacturing part number.

32. A data storage media with computer executable instructions for mapping internal part numbers to manufacturer part numbers comprising:
instructions for maintaining a database of internal part numbers and manufacturer part numbers correlated to one another;
instructions for displaying an electronically displayable file requesting input of an internal part number and a correlated manufacturer part number;
instructions for determining whether said inputted manufacturer part number is present in said database and is correlated to said inputted internal part number; and
instructions for storing said inputted part number and said correlated manufacturer part number in said database if said inputted manufacturer part number is determined to be absent from said database.

33. The data storage media of claim 32, further including instructions for generating a data set having at least one manufacturer part number stored in said database which is correlated to said inputted internal part number.

34. The data storage media of claim 33, wherein said data set includes a plurality of manufacturer part numbers stored in said database which are correlated to a plurality of internal part numbers stored in said database, said plurality of internal part numbers being correlated to said inputted manufacturer part number.

35. A data storage media with computer executable instructions for mapping internal part numbers to manufacturer part numbers comprising:
instructions for maintaining a database of internal part numbers and manufacturer part numbers correlated to one another;
instructions for displaying an electronically displayable file requesting input of an internal part number;
instructions for determining whether said inputted internal part number is present in said database;
instructions for displaying an electronically displayable file requesting input of a manufacturer part number correlated to said inputted internal part number; and
instructions for storing said inputted internal part number and inputted manufacturer part number correlated to said inputted internal part number into said database if said inputted part number is absent from said database.

36. The data storage media of claim 35, further including instructions for generating a data set having at least one manufacturer part number stored in said database which is correlated to said inputted internal part number if said inputted internal part number is present in said database.

37. The data storage media of claim 36, wherein said data set includes a plurality of manufacturer part numbers stored in said database which are correlated to a plurality of internal part numbers stored in said database, said plurality of internal part numbers being correlated to said at least one manufacturer part number that is correlated to said inputted internal part number.

38. The data storage media of claim 35, further including instructions for inputting a manufacturer part number correlated to said inputted internal part number, in response to said request.

39. The data storage media of claim 38, further including the step of generating a data set having a plurality of manufacturer part numbers stored in said database which are correlated to a plurality of internal part numbers stored in said database, said plurality of internal part numbers being correlated to said inputted manufacturer part number.

40. A data storage media with computer executable instructions for mapping internal part numbers to manufacturer part numbers comprising the steps of:
providing a database of internal part numbers and manufacturer part numbers correlated to one another;
instructions for displaying an electronically displayable file requesting input of at least an internal part number;
instructions for determining whether said inputted internal part number is present in said database and is correlated to at least one manufacturer part number; and
instructions for generating a data set having at least one manufacturer part number stored in said database which is correlated to said inputted internal part number if said inputted internal part number is present in said database.

41. The data storage media of claim 40, further including instructions for outputting said generated data set to a display device.

42. The data storage media of claim 40, wherein said generated data set includes a plurality of manufacturer part numbers stored in said database which are correlated to a plurality of internal part numbers stored in said database, said plurality of internal part numbers being correlated to said at least one manufacturer part number that is correlated to said inputted internal part number.

43. The data storage media of claim 40, further including instructions for storing said inputted internal part number in an inactive records database if said inputted internal part number is absent from said database.

44. The data storage media of claim 43, further including instructions for monitoring subsequently inputted internal part numbers and manufacturer part numbers correlated thereto to determine if said inputted internal part number stored in said inactive records database is present.

45. The data storage media of claim 44, wherein said generated data set includes a plurality of manufacturer part numbers stored in said database which are correlated to a plurality of internal part numbers stored in said database, said plurality of internal part numbers being correlated to said at least one manufacturer part number that is correlated to said inputted internal part number.

46. The data storage media of claim 44, further including instructions for removing said inputted internal part number from said inactive records database if said inputted internal part number is subsequently inputted with at least one correlated manufacturing part number.
